(19) United States
(12) Patent Application Publication
(10) Pub. No.: US 2004/0002953 A1
(43) Pub. Date: Jan. 1, 2004

(54) Page tags for automated document processing

(76) Inventor: Karl Heinz Kremer, Rochester, NY (US)

Correspondence Address: Richard A. Romanchik, Heidelberg Digital L.L.C., 2600 Manitou Road, Rochester, NY, 14624, US

(21) Appl. No.: 10/607,182

(22) Filed: Jun. 26, 2003

Related U.S. Application Data
(60) Provisional application No. 60/392,304, filed on Jun. 28, 2002.
(60) Provisional application No. 60/401,703, filed on Aug. 7, 2002.

(51) Int. Cl. G06F 7/00

(52) U.S. Cl. 707/1

(57) ABSTRACT

In accordance with the invention, there is a system for processing at least one page of at least one document. The system comprises at least one input interface and at least one document production system. The input interface is operatively connected to the document production system. The input interface transmits at least one page of at least one document to the document production system. The at least one document production system utilizes a program to assign at least one indicator to the at least one page of the at least one document. In a response to the at least one indicator, the at least one document production system separates the at least one page of the at least one document from other pages of the at least one document.

This application hereby claims the benefit of provisional applications serial Nos. 60/392,304 filed on Jun. 28, 2002 and 60/401,703 filed Aug. 7, 2002.

This invention relates to a system and method for managing document production by tagging pages of a document for different treatment.

### BACKGROUND OF THE INVENTION

Typically, a document may be inputted into a document production system for printing. A page of the document may include black content or graphics information, color content or graphics information, or both. In the prior art, different printers separated the pages containing black content from the pages containing color content information for printing. First, an operator may inspect the document to check for the presence of pages having color content information in order to separate the black content pages from the color content pages of a document prior to printing. Next, an operator may print the color content pages on a color press or another color printer. Third, the operator may treat the printed color content as inserts into a black and white printer. The operator may define job settings so that the black and white printer automatically inserts the correct pre-printed color content pages in the proper alignment with the black content pages of the print job.

The foregoing procedure is labor intensive, error-prone, and time consuming. The operator manually inspects the print job for the presence of color content information or color images, which may lead to a failure to identify all color content information pages of a print job, because the operator may be indifferent, fatigued, etc. The operator utilizes multiple printers with different capabilities to complete a single print job, in which the color printing must be completed prior to beginning the black content process. Accordingly, any delay in the color printing process delays the subsequent black content printing process. The operator may program the job settings of the document production system and load inserts into the proper input sources to properly introduce the pre-printed color inserts into the black content printing process. Thus, a need exists for automating the separation of color content pages of a document from black content of the document.

### BRIEF SUMMARY OF THE INVENTION

In accordance with the invention, there is a system for processing at least one page of at least one document. The system comprises at least one input interface and at least one document production system. The input interface is operatively connected to the document production system. The input interface transmits at least one page of at least one document to the document production system. The at least one document production system utilizes a program to assign at least one indicator to the at least one page of the at least one document. In a response to the at least one indicator, the at least one document production system separates the at least one page of the at least one document from other pages of the at least one document.

In another embodiment of the invention, there is a document production system. The document production system is configured to receive at least one page of at least one document. The document production system is configured to utilize a program to assign at least one indicator to the at least one page of the at least one document. In a response to the at least one indicator, the at least one document production system separates at least one page of the at least one document from other pages of the at least one document.

In yet another embodiment of the invention, there is a method for processing at least one page of at least one document. This method receives the at least one page of the at least one document, and then assigns at least one indicator to the at least one page of the at least one document. This method also separates at least one page of the at least one document from other pages of the at least one document as a response to the at least one indicator.

### BRIEF DESCRIPTION OF THE DRAWINGS

FIG. 1 illustrates communication between an input interface and a document production system;

FIG. 2 is a block diagram of an embodiment of a document production system in accordance with the invention;

FIG. 3 is a block diagram of another embodiment of a document production system in accordance with the invention; and

FIG. 4 is a flow chart illustrating an implementation of the invention.

### DETAILED DESCRIPTION OF THE INVENTION

The present preferred embodiments of the invention are described herein with references to the drawings, wherein like components are identified with the same references. The descriptions of the preferred embodiments contained herein are intended to be exemplary in nature and are not intended to limit the scope of the invention.

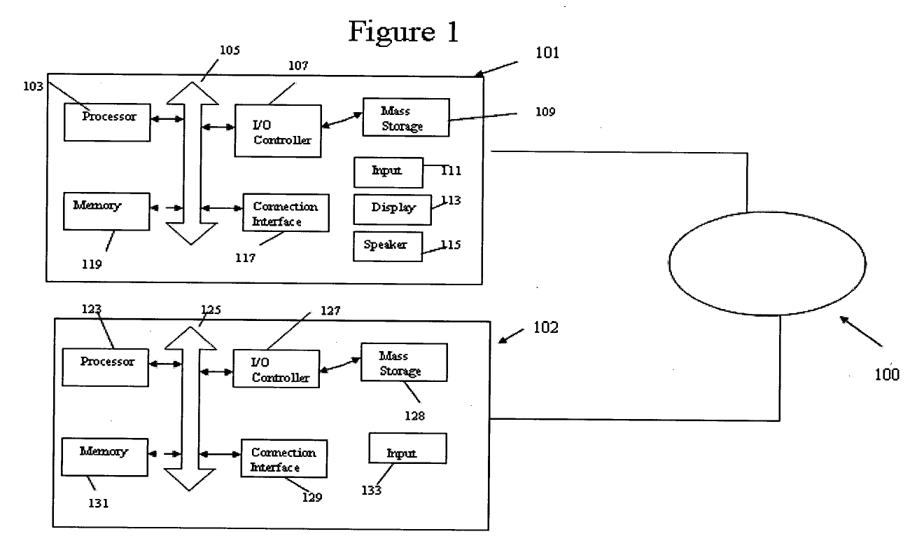

FIG. 1 illustrates a communication between an input interface and a document production system. In this example, data or information from at least one input interface 101 is transferred through an interconnection of at least one network 100 to at least one document production system 102. Input interface 101 may also be an integral portion of the document production system 102, where the data or information is simply downloaded into the document production system 102. Input interface 101 is also interconnected to network 100. Network 100 represents, for example, the Internet, which is an interconnection of networks. In addition, network 100 may be a local access network, a wireless local network, a wide area network, a metropolitan area network, a virtual area network or any network that may be able to facilitate the transfer of data between computers or servers.

Input interface 101 includes conventional components such as a processor 103, an input/output (I/O) controller 107, a mass storage device 109, an input device 111, a display device 113, at least one speaker 115, a connection interface 117, and a memory 119. The processor 103, memory 119, I/O controller 107, and the connection interface 117 are interconnected through a bus 105.

Mass storage device 109 is interconnected to the main portions of the input interface 101 through I/O controller 107. Input device 111 can be a keyboard, a mouse, a touch screen, a graphical user interface or any other device or method that can be utilized as an input device. Display device 113 is any type of conventional display that may have a liquid crystal display (LCD). Speaker 115 may be any type of conventional speaker. Connection interface 117 provides an operative connection from input interface 101 to network 100. The architecture illustrated in the input interface 101 is typical for a personal computer “PC” type, where any type of computer is capable of operating as a server.

Document production system 102 includes conventional components such as a processor 123, an input/output (I/O) controller 127, a mass storage device 128, a connection interface 129, a memory 131, and an input device 133. Input device 133 is equivalent to input device 111, described above. The processor 123, memory 131, I/O controller 127, and the connection interface 129 are interconnected through a bus 125.

Mass storage device 128 is interconnected to the main portions of the document production system 102 through I/O controller 127. Even though it is not shown document production system 102 may also include: a display device, and at least one speaker. Connection interface 129 provides an operative connection from document production system 102 to network 100. The architecture illustrated in the document production system 102 is typical for a personal computer “PC” type, where any type of computer is capable of operating as a server.

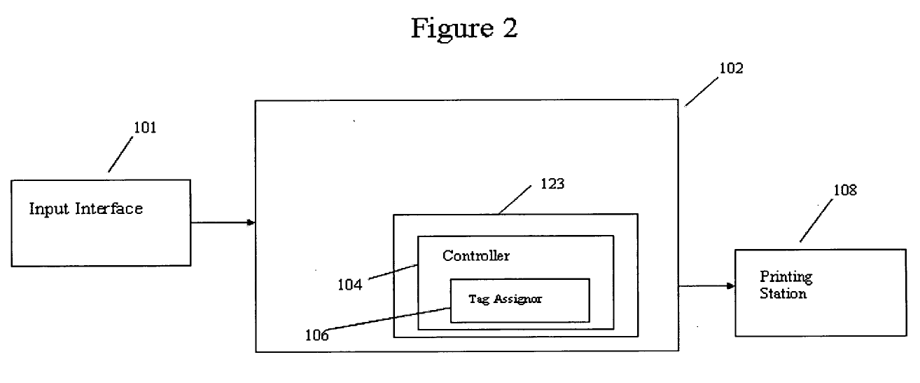

FIG. 2 illustrates an input interface operatively connected to a document production system. The processor 123 includes a controller 104 and a tag assignor software program 106. Controller 104 processes print jobs in the document production system 102. Tag assignor software program 106 is part of ImageSmart Document Mastering software program that is utilized for assigning tags to at least one page of at least one document and/or at least one page of a plurality of documents. In this specification, the term “communicates” may be referred to as an “operative connection”. The term “content” as used in this specification includes text and images. The processor 123 includes a link or a connection to at least one printing station 108, where the processor 123 forwards at least one electronic version of the at least one page of the at least one document to the printing station 108. The term “link” or “connection” is equivalent to the term “network”, described above. The printing station 108 and/or a first printing station 110 and a second printing station 112 receive at least one electronic version of the at least one page of the at least one document. The printing station 108, first printing station 110 and a second printing station 112 may be a black and white printer, a color printer, an image printer, a laser printer, a photo printer, a dot matrix printer or any printer that is known to those of ordinary skill in the art.

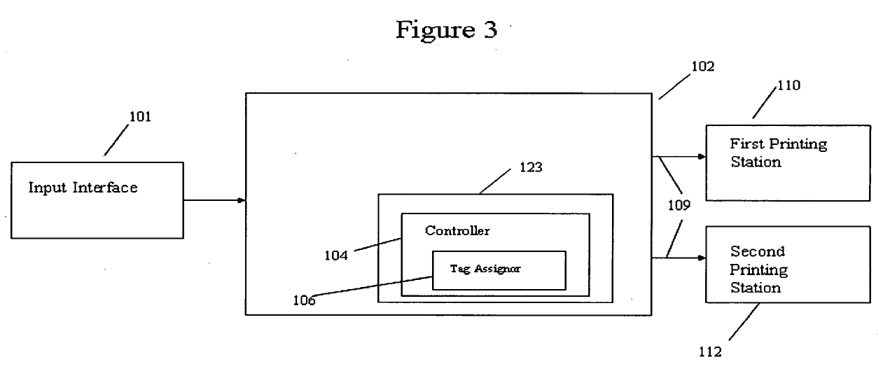

FIG. 3 shows an alternate embodiment of a document production system. The document production system of FIG. 3 is similar to the document production system 102 of FIG. 1, except that there are two printing stations utilized instead of one printing station. Further, the processor 123 communicates directly or indirectly with the first printing station 1 10 and the second printing station 112. For example, the processor 123 may communicate with the first printing station 110, the second printing station 112 or both, via a dedicated link, such as a network 109 that may be placed in between document production system 102 and the first printing station 110 and the second printing station 112. The term “network” is equivalent to network 100, described above.

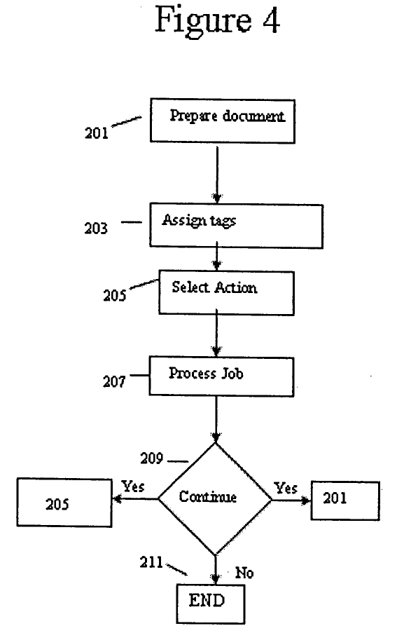

FIG. 4 is a flow chart illustrating an implementation of this invention. In 201, a user prepares a document by submitting at least one document having at least one page or a plurality of pages. The user may establish the preparation of the document through an interaction with the input interface 101. The input interface 101 may support establishing the preparation of the document through one or more of the following techniques: (1) entering data into a keyboard or graphical user interface, (2) entering a file on a storage medium or media into the document production system, (3) scanning a document to place the document in a suitable electronic format for processing by the document production system 102. Those of ordinary skill in the art recognize that there may be more methods or means utilized to input at least one document into the document production system 102.

The document in an electronic version or by any other means is transmitted through network 100 to the document production system 102. If input interface 101 is a part of the document production system 102, then the document is simply downloaded onto the document production system 102. Document production system 102 utilizes the input device 133 or the input device 111 on input interface 101 to initiate the utilization of Adobe Acrobat on a display device (not shown). At least one image of the at least one page of the document may be shown on the display device. Then, the user utilizes the input device 133 to communicate with controller 104. Controller 104 communicates with the tag assignor software program 106 or program to initiate Acrobat Thumbnail view.

In 203, input device 133 through the tag assignor software program 106 utilizes Acrobat Thumbnail view and the standard Acrobat tools to assign at least one indicator or tag, such as at least one image tag, at least one color content information tag, at least one special name tag, at least one black content information tag, at least one photographic image tag, any combination thereof or any other type of tag on any page of the plurality of pages of the at least one document. The assigned tag acts as an indicator to instruct the processor that a special processing should be done, for example, color images should be printed on an image printer. In addition, at least one page of the document may be tagged for special processing (e.g., to print certain pages on a certain medium). Further, the special processing can be for color content, black content, at least one special name, etc.

A medium may comprise paper, colored paper, transparent film, a polymeric film, a paper product, a divider, a tabbed sheet, a sheet, or another printable product. The user, an operator, or customer of input interface 101 or document production system 102 may select pages that require a particular media or medium based upon the presence of tags associated with the pages of a document.

It is also possible to add an automatic tagging process that would parse the document and tag all pages meeting a specific criteria, for example, pages that are of a certain size (e.g. 9×11″) or pages containing color content. The advantage of these page tags versus the manual selection is that the user or operator can assign a special tag to a page once and then forget about which pages are tagged. The document production system 102 keeps track of the assigned tags and any additional information that is assigned to the pages of a document. The document production system handles the processing and preservation of the tags, so as to free the user to concentrate on the creative process of authoring the document.

The input device 133 may be utilized to tag one page or a set of individual pages with a string to indicate that one page or a set of pages, for example, contains color content. The tag for each individual page is stored on each individual PDF page of at least one page of the document that was tagged and stored as a private PDF object. Each PDF page can hold a plurality of tags, so at least one page of the at least one document may have a plurality of tags.

In 205, after the at least one page of the document is tagged, then the user selects an action or decides to process the at least one page of the document that is tagged by utilizing input device 133. Input device 133 uses menu entries associated with ImageSmart Document Mastering software to perform various processes or instructions, such as removing tagged pages from the at least one document, saving tagged pages as at least one new document, moving tagged pages to at least one new document, copying tagged pages to at least one new document, printing tagged pages of the at least one document, printing pages without tags of the at least one document, excluding tagged pages from printout of the at least one new document and any other routine that may be assigned to a set of pages of the at least one document or at least one new document. Thus, the user will be able to separate at least one page of the document from other pages of the document based on the indicator. The term “processing” is defined as the ability of input device 133 through menu entries associated with ImageSmart Document Mastering software to perform various instructions on the at least one page of the document.

At least one instruction submitted by the user through the menu entries may be stored on processor 123, where processor 123 may transmit these instructions to at least one printing station 108, or first printing station 110 and second printing station 112. For example, the input device 133 through Adobe Acrobat utilizes tag assignor software program 106 to select original medium or plain medium of page 5 to be tagged so the content will be printed on blue medium. Then the input device 133 utilizes menu entries to remove the blue medium tag from page 5 so page 5 will not be printed on blue medium. When page 5 is printed this page will be printed on the plain medium, instead of blue medium.

In 207, the job is processed or the action is processed by processor 123. For example, the user may decide to save the at least one page with the assigned tag of the document on a file and end this program. The user may be able to access this program at a later date, where he can download the file with the at least one page of the assigned tag document and print out the document on the printing station 108, first printing station 110 and/or the second printing station 112. In another example, the printing station 108, the first printing station 110 and/or second printing station 112 receives instructions from processor 123. At the printing station 108, the print job may include a number of different tagged pages such as color content information and black content information that may be separated for each page of the at least one document. Based on the tagged information stored in the processor 123, processor 123 transmits the instructions to the printing station 108 as to how each page of the document should look, for example, if at least one page of the document should be printed with black content and/or color content etc. Accordingly, the user or an operator can maintain one document file, but is still able to produce different versions of the document from the single document file.

In 209, the user must decide if he wants to continue this process or not. If he chooses to continue, then he may choose to continue at 201 or 205 depending on which part of the process the user wants to utilize. If the user wants to reinitiate the process, then he can return to 201 where he is able to submit another document that may be tagged. In addition, the user may re-submit the at least one page of the document that is tagged. If the user is at the stage where he is changing an electronic version of the document to include or exclude certain tagged pages, then the user may choose to continue at 205. The user may also choose to end this process at 211.

In an example, a training manual may be the document submitted to the input interface 101, where a user desires two different versions of the training manual be printed. The training manual in an electronic version is tagged by the user utilizing input device 133 that works with the tag assignor software program 106, as discussed above, where the training manual includes an instructional chapter, a test chapter and current test results.

Tag assignor software program 106 tags only the pages containing the instructional chapter, test chapter and the current test results with the special name to tag “Instructor Copy,” then processor 123 processes and stores this tagged information. Tag assignor software program 106 also tags the pages containing instructional chapter and test chapter with the special name tag “Student Copy”, then processor 123 processes and stores this tagged information. The user is then able to access the document by utilizing input device 133 with menu entries, which allows the user to transmit instructions to processor 123 to remove the tagged pages, print the tagged pages, exclude the tagged pages from printing etc. The user utilizes input device 133 with menu entries to transmit instructions to processor 123 to print the Student copy tagged pages at the printing station 108, so that the only pages of the document printed contain the instruction chapter and a test chapter. After, the first print job is done, then the user, returns to 205, where he is able to utilize the input device 133 with menu entries to transmit instructions to processor 123 to print the document with the Instructor copy tagged pages at the printing station 108, so that the instructor chapters, test chapter and current results are printed. Thus, the user is able to utilize this process to separate an electronic version of the document into at least two different versions.

In yet another example, a user may submit a print job through input interface 101 the print job includes three documents each document containing 40 pages. In the documents, pages 15-25 of each document include color content while pages 1-14 and 26-40 contain black content information. It may be more effective to utilize at least two printing stations for this print job, because the first printing station 110 is a color content printer and the second printing station 112 is a black content printer. A user or an operator through input device 133 can utilize the tag assignor software program 106 to tag pages 15-25 as color content while the original content information for pages 1-14 and 26-40 may remain the same or be tagged as black content information. The input device 133 with the menu entries transmits instructions to the processor 123 as to how the pages should be printed based on the tagged information.

Processor 123 transmits instructions for printing the document to the first printing station 110 and the second printing station 112. For instance, processor 123 transmits instructions to the first printing station 110 to print pages 15-25. After the first print job, the user returns to 205 where the user utilizes the input device 133 and menu entries to instruct processor 123 that the pages not tagged or pages 1-14 and 25-40 should be printed on printing station 112.

The foregoing description of the invention describes several illustrative embodiments. Other embodiments, variations, alterations or alternatives may fall within the scope of the invention and the following claims. Accordingly, the claims should be accorded the broadest interpretation possible consistent with the specification set forth in the description.

1. A system for processing at least one document, the system comprising:
at least one input interface;
at least one document production system operatively connected to said at least one input interface;
wherein the at least one input interface transmits at least one page of at least one document to the at least one document production system, wherein the at least one document production system utilizes a program to assign at least one indicator to the at least one page of the at least one document; and
responsive to the at least one indicator, the at least one document production system separates the at least one page of the at least one document from other pages of the at least one document.

2. The system of claim 1, wherein the at least one input interface is operatively connected to the at least one document production system by at least one network.

3. The system of claim 1, wherein the program is a tag assignor software program.

4. The system of claim 1, wherein the at least one indicator is at least one instructor tag.

5. The system of claim 1, wherein the at least one indicator is at least one color content tag.

6. The system of claim 1, wherein the at least one indicator is at least one black and white content tag.

7. The system of claim 1, further comprising at least one printing station.

8. The system of claim 7, wherein the at least one printing station receives instructions from the document production system to print the at least one page of the at least one document separately from the other pages of the at least one document.

9. An apparatus comprising:
at least one document production system configured to receive at least one page of at least one document; and
a program operating in said at least one document production system to assign at least one indicator to the at least one page of the at least one document, and wherein responsive to the at least one indicator, the document production system separates at least one page of the at least one document from other pages of the at least one document.

10. A method for processing at least one page in at least one document:
receiving at least one page of the at least one document; assigning at least one indicator to the at least one page of the at least one document; and
separating at least one page of the at least one document from other pages of the at least one document as a response to the at least one indicator.

11. The method of claim 10, wherein the at least one indicator is an assigned tag.

12. The method of claim 10, wherein the at least one indicator is an instructor tag.

13. The method of claim 10, wherein the at least one indicator is at least one color content information tag.

14. The method of claim 10, wherein the at least one indicator is at least one black and white content information tag.

15. The method of claim 14, wherein the color content of the at least one page is printed at a first printing station and the other pages of the document are printed at a second printing station.

16. The method of claim 10, further comprises storing the at least one indicator on a PDF page of the at least one page.

17. The method of claim 10, further comprises moving the page with the at least one indicator of the at least one page to a new document.

18. The method of claim 10, further comprises printing the separated at least one page in combination with the other pages of the document.

19. The method of claim 10, further comprises printing the other pages of the document.

20. The system of claim 1, wherein the at least one indicator is at least one student tag.

21. The method of claim 10, wherein the at least one indicator is an student tag.
